(19) United States
(12) Patent Application Publication
(10) Pub. No.: US 2013/0054330 A1
(43) Pub. Date: Feb. 28, 2013

(54) METHODS AND SYSTEMS FOR COLLECTIVE PURCHASING VIA AN ONLINE STORE

(71) Applicants: Ryan O'Donnell, Brooklyn, NY (US); Marco DiDomenico, Cuyahoga Falls, OH (US)

(72) Inventors: Ryan O'Donnell, Brooklyn, NY (US); Marco DiDomenico, Cuyahoga Falls, OH (US)

(21) Appl. No.: 13/591,222

(22) Filed: Aug. 22, 2012

Related U.S. Application Data
(60) Provisional application No. 61/528,378, filed on Aug. 29, 2011.

(51) Int. Cl. G06Q 30/06; G06Q 30/02

(52) U.S. Cl. 705/14.23; 705/26.1; 705/27.1

(57) ABSTRACT

Computer-implemented methods and systems for collective purchasing via an online store are disclosed. The disclosed methods and systems allow a group of people to make a collective online purchase of a single product or a service. A user may select a product in the online store and send a request to purchase a share of the product. To purchase the share of the product, the user may make monetary or non-monetary contributions to purchase the share of the product. Additionally, the user may invite other users to purchase other shares of the product, and each time a new share is purchased, it may be added to collective purchased share. If the amount of the collective purchased share is equal to or exceeds the total cost of the product, the product may be purchased and delivered to an intended recipient in the form of a gift or donation.

### CROSS-REFERENCE TO RELATED APPLICATIONS

This application claims priority of U.S. Provisional Application No. 61/528,378, entitled “METHODS AND SYSTEMS FOR ATTRIBUTING SIMULATED PRODUCTS TO INTENDED RECIPIENTS WITHIN A RETAIL SYSTEM,” filed Aug. 29, 2011, which is incorporated herein by reference in its entirety for all purposes.

### FIELD

This disclosure relates generally to transmission of digital information and more particularly to computer-implemented methods and systems for collective purchasing via an online store.

### BACKGROUND

The approaches described in this section could be pursued but are not necessarily approaches that have been previously conceived or pursued. Therefore, unless otherwise indicated, it should not be assumed that any of the approaches described in this section qualify as prior art merely by virtue of their inclusion in this section.

Lately, electronic commerce, commonly known as e-commerce or online shopping, has grown significantly. E-commerce refers to the process of buying and selling products or services over electronic systems, such as the Internet or any other computer network. E-commerce may be conducted entirely in an electronic form for virtual items, such as the access to specific content of a website, or it may involve delivering real items or services in some other way.

Various electronic systems and online services have been developed to assist consumers in making decisions regarding purchases of different products over the Internet. The purchase of different products over the Internet involves selecting a product, indicating an address for delivery, and using credit cards (or any other payment cards) to pay for the product. Additionally, the consumers may purchase different products as gifts for their relatives or friends. In this case, the consumers may indicate a delivery address as the address of intended recipients. It is also common for online retailers to sell gift cards. The consumers may specify the amount of credits or currency to be available on such cards.

Numerous online retail shops allow consumers to buy products or services individually. However, when a group of people is willing to purchase a single product or service, such people may wish to share associated expenses. Performing such collective payments may cause difficulties, since most online stores may only process a single credit card for a single purchase.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are methods and systems for collective purchasing via an online store. In general, these methods and systems allow a group of people to make a collective online purchase of a single product by purchasing shares of the product.

According to the methods and systems disclosed herein, a user may make a request to purchase a share of a product via an online store. The user may specify various details of a future purchase, such as details of an intended recipient and details for shipping and delivery. To pay for a share, the user may use monetary or non-monetary contributions. Additionally, the user may invite other users (e.g., relatives, friends, colleagues) to make purchase shares of the product in order to cover a total cost of the product. After a share of the product has been purchased, it may be determined whether a collective purchased share is equal to or exceeds the total cost of the product. When the total cost of the product is covered by the collective purchased share, the product may be delivered to the intended recipient.

### BRIEF DESCRIPTION OF THE DRAWINGS

Embodiments are illustrated by way of example and not limitation in the figures of the accompanying drawings, in which like references indicate similar elements and in which:

FIG. 1 shows a block diagram illustrating a system environment suitable for collective purchasing via an online store, according to an example embodiment.

FIG. 2 is a block diagram illustrating a sample system for collective purchasing via an online store, according to an example embodiment.

FIG. 3 is a process flow diagram showing a method for collective purchasing via an online store, according to an example embodiment.

FIG. 4 is a simplified illustration of a graphical user interface of a product page at a retail store for selecting/customizing the product and its purchasing, according to an example embodiment.

FIG. 5 is a simplified illustration of a graphical user interface for a purchase page, according to an example embodiment.

FIG. 6 is a diagrammatic representation of an example machine in the form of a computer system within which a set of instructions for causing the machine to perform any one or more of the methodologies discussed herein is executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments may be combined, other embodiments may be utilized, or structural, logical and electrical changes may be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The embodiments described herein relate to computer-implemented methods and systems for collective purchasing via an online store.

In the specification the following terms are used:

The terms “product” or “group gift,” as used herein, refer to an article, a virtual or real item, a service, an experience, and so forth. The product may be selected or customized both by a consumer and a retailer.

The term “user,” as used herein, refers to a consumer or a potential consumer.

The term “share,” as used herein, refers to a virtual part of a product. Shares may have a certain price, and their number may be limited such that the entire price for all shares is equal to the product price.

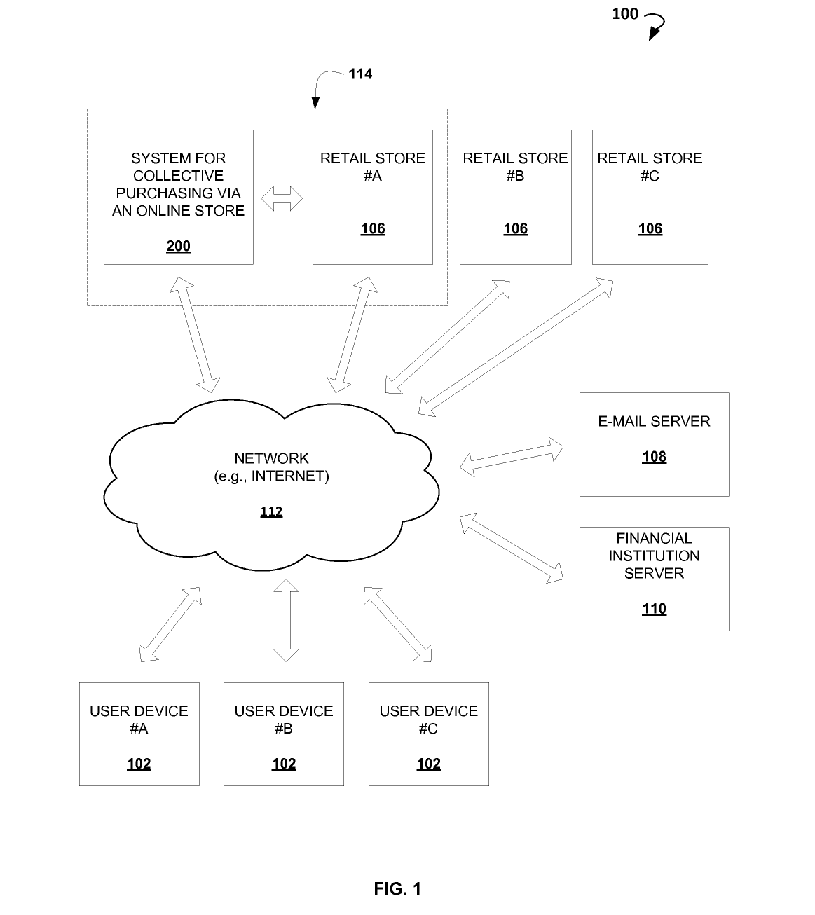

Referring now to the drawings, FIG. 1 shows a block diagram illustrating a system environment 100 suitable for collective purchasing via an online store, according to an example embodiment.

The system environment 100 may include one or more user devices 102, a system for collective purchasing via an online store 200, one or more retail stores 106, an e-mail server 108, a financial institution server 110, and a network 112.

The network 112 may be a network of data processing nodes interconnected for the purpose of data communication, which may be utilized to communicatively couple various components of the system environment 100. The network 112 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port, such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 112 may further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

The user device 102 may include a personal computer (PC), a laptop, a tablet computer, a portable computing device, a personal digital assistant (PDA), a handheld cellular phone, a mobile phone, a smart phone, a handheld device having wireless connection capability, or any other electronic device suitable for communicating data via the network 112.

The user devices 102 may be configured to browse websites or access remote servers via the network 112. For example, the user devices 102 may be used to make purchase decisions at the one or more retail stores 106. In some embodiments, the user device 102 may include a browser providing the ability to browse and interact with sites on online resources.

The system for collective purchasing via an online store 200, according to various embodiments disclosed herein, may be configured to receive and process user requests to purchase one or more shares of a product, secure payments of such shares, combine purchased shares (collective purchased share), and determine whether the collective purchased shares reach a total cost of the product.

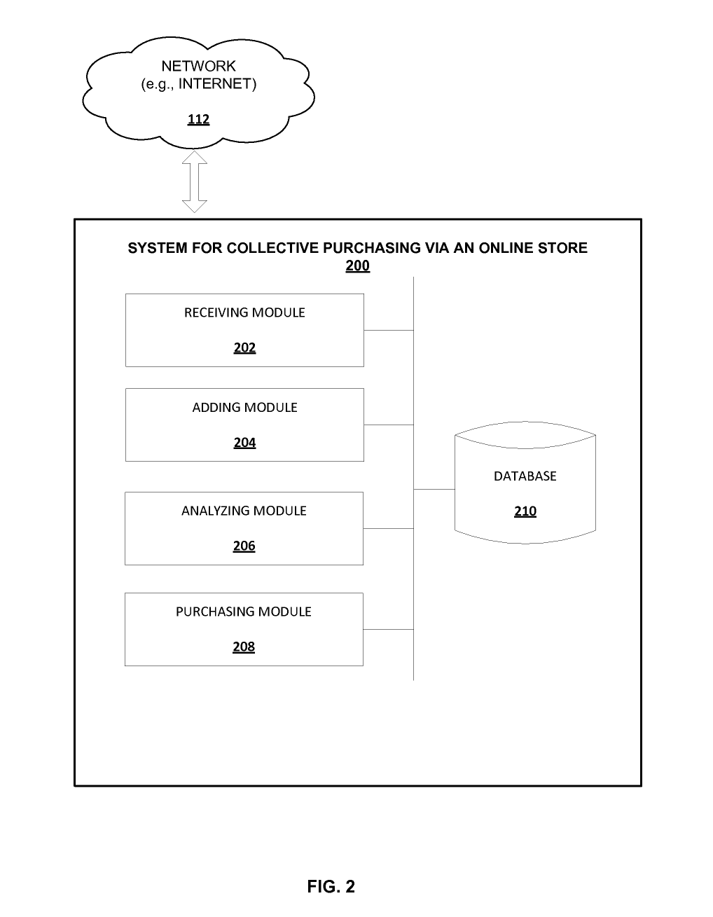

The system for collective purchasing via an online store 200 may be implemented as a remote server having multiple modules and databases accessible over the network 112. The remote server may optionally host a website to process purchases of shares and provide other functionality as further described. The system for collective purchasing via an online store 200 is described in detail below with reference to FIG. 2.

According to various embodiments disclosed herein, the one or more retail stores 106 may include online resources, which provide e-commerce services for individuals or businesses. In one example, the retail store 106 is a web server hosting a website allowing users to make online purchases of products. Typically, the retail store 106 may provide access to an inventory list for the users to select and/or customize the product and to purchase such product.

The retail store 106 and the system for collective purchasing via an online store 200 may be virtually considered as a retail system 114. Accordingly, such a retail system 114 allows users to select/customize a specific product at the retail store 106, and the product purchase may be processed by the system for collective purchasing via an online store 200 when the product is intended to be purchased by a group of people.

In one example, the retail store 106 and the system for collective purchasing via an online store 200 may reside at a single server and represent a single unit. Alternatively, they may be remotely located and communicate with each other over the network 112.

According to some embodiments, users may be redirected from the retail store 106 to the system for collective purchasing via an online store 200, or vice versa. For example, when the users make a purchase of shares, they may be forwarded to the system for collective purchasing via an online store 200. Alternatively, the users located at the system for collective purchasing via an online store 200 and wishing to learn more about the product may be forwarded to the retail store 106.

In yet another example, the system for collective purchasing via an online store 200 may include one or more widgets for virtual embedding into the retail store 106. Such widgets may be represented by one or more clickable buttons or actionable elements to set details of a user, a purchase, a product, an intended recipient, and so forth.

According to some embodiments, the system for collective purchasing via an online store 200 may virtually form multiple retail systems 114 with different retail stores 106.

The e-mail server 108 may transfer e-mail messages from one computer to another computer, using client-server application architecture. The e-mail server 108 may be used by one user device 102 to send a message to another user device 102, or may be used by the system for collective purchasing via an online store 200 and the retail store 106 to send messages to the user devices 102.

The financial institution server 110 may include a banking server, a clearing server, a credit/debit/prepaid card server, a virtual account server, an on-line banking server, and so forth. In this disclosure, the term “financial institution” means any organization in the business of transacting money and providing financial services. Financial institutions, such as commercial banks, provide services related to establishing bank accounts, cash withdrawals and deposits, issuing credit cards and debit cards, and so forth. The financial institution server 110 may be associated with user payment cards (such as credit, debit or prepaid cards), and it may be used to make payments by cardholders and/or receive payments from any organizations or individuals.

According to some embodiments, securing payments for product shares may be performed by processing credit/debit/prepaid transactions of users by one or more financial institution servers 110, which may request and process payment card details to issue payment card authorization codes for the system for collective purchasing via an online store 200 to complete payments.

FIG. 2 is a block diagram of the system for collective purchasing via an online store 200, according to an example embodiment. In this embodiment, the system 200 may include a receiving module 202, an adding module 204, an analyzing module 206, a purchasing module 208, and a database 210. The system for collective purchasing via an online store 200 and the database 210 may be accessible over the network 112.

In other embodiments, the system for collective purchasing via an online store 200 may include additional, fewer, or different modules for various applications. Furthermore, all modules may be integrated within a single apparatus, or, alternatively, may be remotely located and optionally be accessed via a third party.

The system for collective purchasing via an online store 200 may be implemented as hardware having software installed thereon that implements any steps necessary to operate the system for collective purchasing via an online store 200, according to various embodiments disclosed herein. The system for collective purchasing via an online store 200 may also host a website intended to, among other things, store, aggregate, and communicate user details, product details, intended recipient details, and so forth.

According to various embodiments, the users may register in the system for collective purchasing via an online store 200 and create a virtual member profile. In this case, the membership details are stored in the database 210. The membership profiles may include personal information, such as a name, a nickname, user credentials, a representative picture/photo/logo, an address, a phone number, a fax number, an e-mail address, a web address, links to the membership details or personal pages at blogging or social networking services, or any other form of contact and personal information. The users may optionally manage their profiles. Additionally, the system for collective purchasing via an online store 200 may manually or automatically access the one or more retail stores 106 to provide or request certain information on users, products, or payment details. According to another example, the system for collective purchasing via an online store 200 may also allow the users to share information with other users or potential users. For example, the users may send invitations to other users to participate in the collective purchasing of a certain product, which, when purchased, may be delivered to an intended recipient.

The receiving module 202 may be configured to receive user requests to purchase a share of a product. The purchase of the share may be performed by means of the purchasing module 208. To purchase the share of the product, the user may use a payment card. However, payments may be both monetary and non-monetary. When payments are monetary, such payments may be processed by financial institution servers 110. When payments are non-monetary (e.g., points, credits, miles, and the like), such payments may be processed by the retail store 106 or any other system associated with non-monetary funds.

Each selection of a product and each purchase of shares are recorded in the database 210. The database 210 may include one or more of the unique identifier of the product, identifiers of users, purchase amounts, a calculation of the aggregated contributions, a number of purchased shares, a percentage of purchase amount, and so forth. Accordingly, the information in the database 210 is updated each time new shares of the product are purchased.

Each time a new purchase of shares is made, the users are prompted by the system for collective purchasing via an online store 200 to invite other users to purchase shares related to the same product. Such invitations may be sent as e-mail messages, instant messages, SMS, MMS, postings at blogging or social networking websites, and so forth.

The receiving module 202 may also be configured to determine whether one or more invited users and/or intended recipients are registered within the retail system 114. If the one or more invited users and/or intended recipients are not registered within the retail system 114, the receiving module 202 may prompt the one or more invited users and/or intended recipients to create a new virtual account.

The receiving module 202 may also be configured to receive and process credential data associated with users and authenticate users within the retail system 114. The receiving module 202 may optionally be configured to prompt users to input details or select the intended recipient of the product, to select the input details or customize details of the product to be purchased, or to select or set price details related to the product or product shares.

The adding module 204 may be configured to combine one or more purchased shares with previously purchased shares of the product. The adding module 204 may also calculate the total amount of all user contributions (payments), the percentage of all purchased shares, and so forth.

The analyzing module 206 may be configured to analyze whether a total amount of all purchased shares is equal to or exceeds the total cost of the product. Specifically, the analyzing module 206 may determine whether the percentage of all purchased shares is equal to or more than 100%. Alternatively, the analyzing module 206 may determine whether the total amount of all user contributions (payments) is equal to or more than a product price. Those skilled in the art would readily understand that different techniques may be used.

If the total amount of purchased shares equals or exceeds the total amount of the product, the product purchase may be processed by the purchasing module 208, and the product may be delivered to the intended recipient.

When the total amount of all purchased shares exceeds the total cost of the product (e.g., when the percentage is over 100%), the users or the intended recipient may be provided with one or more of the following options: a gift card or retail store credit associated with a balance, a recommendation to purchase a different product having a price equal to or less than the balance, a refund, and so forth.

The database 210 may be configured to store information on products (e.g., product identifiers), users who made purchases (e.g., user identifiers), purchased amounts, settings, membership related information, recipient details (such as user profiles and their personal information), and so forth. The users may optionally access the database 210 in order to update the information.

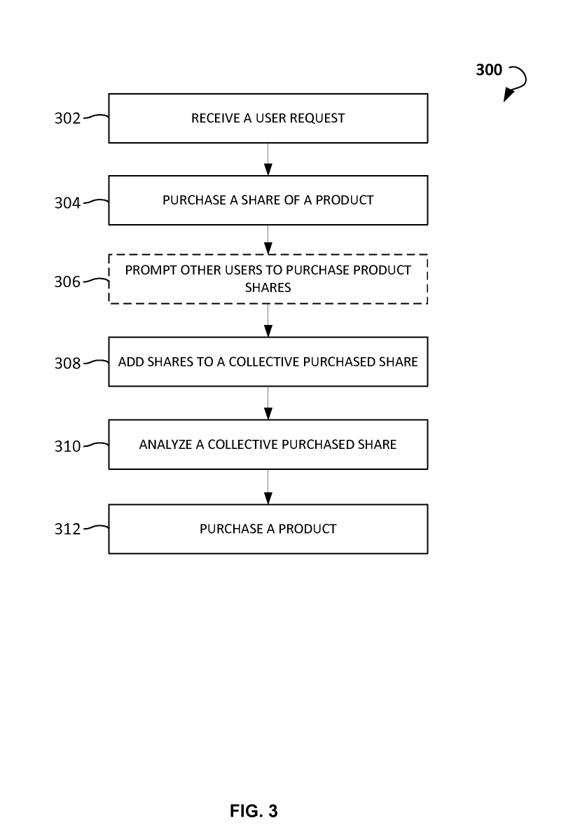

FIG. 3 is a process flow diagram showing a method 300 for collective purchasing via an online store, according to an example embodiment. The method 300 may be performed by processing logic that may include hardware (e.g., dedicated logic, programmable logic, and microcode), software (such as software run on a general-purpose computer system or a dedicated machine), or a combination of both. In one example embodiment, the processing logic resides at the retail system 114 or the system for collective purchasing via an online store 200.

The method 300 may be performed by the various modules discussed above with reference to FIG. 2. Each of these modules may include processing logic. It will be appreciated by one of ordinary skill that examples of the foregoing modules may be virtual, and instructions said to be executed by a module may, in fact, be retrieved and executed by a processor. The foregoing modules may also include memory cards, servers, and/or computer discs. Although various modules may be configured to perform some or all of various steps described herein, fewer or more modules may be provided and still fall within the scope of various embodiments.

As shown in FIG. 3, the method 300 may commence at operation 302 with the receiving module 202 receiving a user request related to the product. At operation 302, the user may select and/or customize a product within the retail system 114. The product may be related to a real or virtual item, article, or service. At operation 302, the user is prompted to select the intended recipient of the product, or input details of the recipient such as name, address, contact information, and so forth. The user may also select settings for purchasing and delivering the product. For example, the user may indicate a date of delivery, select an occasion if a product ID is a gift, select an amount and/or number of shares to purchase, a price per share, and so forth. Upon selection of the product and all settings, the price details related to the product or product shares are generated. Such price details may include one or more of a product price, taxes, a shipping price, and a delivery price.

At operation 302, the user may also be optionally authenticated by the retail system 114. The authentication may be performed by requesting and processing user credentials.

At operation 302, a user request to purchase one or more shares of the product is generated and communicated to the system 200. The user request may be associated with, and contain data related to, the user, the product (e.g. a unique product identifier), the settings, and the intended recipient. Based on this information, the system for collective purchasing via an online store 200 may generate a database to track further purchases of product shares.

At operation 304, the user is enabled to purchase a share of the product. The purchase may be processed by requesting a payment card authorization code and securing payment using the payment card authorization code. Upon successful payment, a unique purchase identifier may be optionally generated. The payment details get stored to the updated database. The database may include one or more of the following: a unique product identifier, a unique user identifier, purchase amounts, the unique purchase identifier, product price details, the percentage of purchase amount related to the whole product, and so forth. Upon purchase, the user may also be prompted to leave a message for the intended recipient. Such message may contain text, images, video, and audio content, and may be delivered to the intended recipient upon product delivery. Additionally, upon a successful purchase, the user may be provided with a corresponding receipt.

In some embodiments, at operation 306, the user is prompted to invite other users to purchase product shares. Invitations may be sent by the user automatically via e-mail, blogging messages, social network messages or posts, SMS, MMS, and the like. Similarly, the invited or non-invited users may purchase the remaining shares of the product. At operation 308, the system for collective purchasing via an online store 200 combines all purchased shares of the product.

At operation 310, a determination is made as to whether the total amount of all purchased shares is equal to or exceeds the total cost of the product. The analysis may be performed by calculating the percentage of all purchased shares. For example, the percentage of all purchased shares may be compared with 100%. Otherwise, the collected amount of currency may be compared with the entire price of the product. Those skilled in the art would understand that different methods may be applied.

If the total amount of all purchased shares is equal to or more than the total cost of the product, the product is selectively attributed to the intended recipient and purchased at operation 312. The product may then be delivered to the intended recipient according to the predetermined settings. The users who made contributions may be notified of product attribution by e-mail or other communication methods. The database may also be correspondingly updated.

When the percentage of all purchased shares and/or the total amount of all user contributions (payments) exceeds the total cost of the product (e.g., when the percentage is over 100%), the users or the intended recipient may be provided with one or more of the following options: a gift card or retail store credit associated with the balance, a recommendation to purchase a different product having a price equal to or less than the balance, or a refund, and so forth.

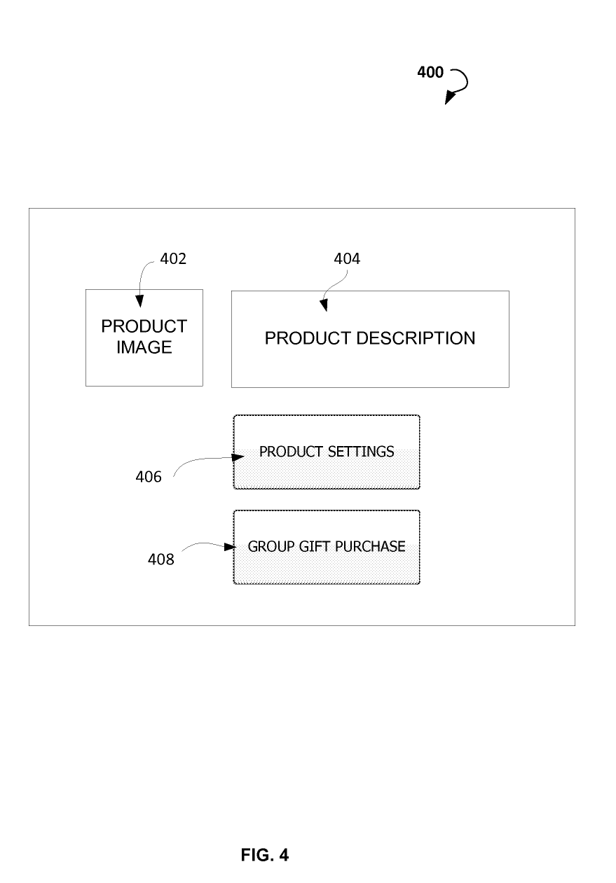

FIG. 4 is a simplified illustration of a graphical user interface 400 of a product page at a retail store for selecting/customizing the product and its purchasing, according to an example embodiment. The graphical user interface 400 may be represented as a window (e.g., a browser window) to show its content. The graphical user interface 400 may be presented on a screen of the user device 102 via a browser.

By way of example and not limitation, the graphical user interface 400 shows the product page related to selecting and purchasing a bunch of flowers. The graphical user interface 400 may include a representative product image 402 of the product, a product description 404 comprising a product price and its specification, a widget 406 to change product settings, and a widget 408 to purchase product shares by a group of people.

The widgets 406 and 408 may be represented as one or more of actionable buttons, radio buttons, cycle buttons, controls, icons, hyperlinks, text boxes, list boxes, check boxes, and so forth. In one example, the widget 406 for changing product settings may allow users to select a product from a retail inventory and/or customize the product. For instance, users may indicate a number and type of flowers that should be used in the bunch of flowers.

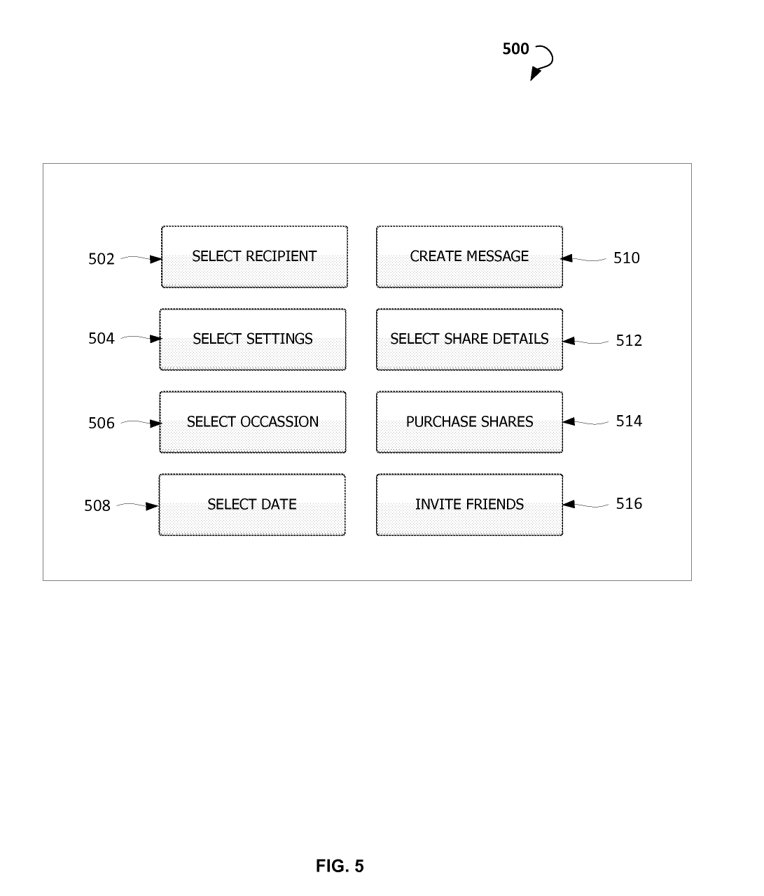

The widget 408 for purchasing the product shares by a group of people may direct users to a different web page which will be described with reference to FIG. 5. The widget 408 may be activated by the user when the user intends to purchase the product and share its costs with other users (friends, relatives, colleagues, and the like). Such purchases may be performed by purchasing shares of the product, as described above.

FIG. 5 is a simplified illustration of a graphical user interface 500 of a purchase page, according to an example embodiment. The graphical user interface 500 may be represented as a window (e.g., a browser window) to show the content. The graphical user interface 500 may be presented on a screen of the user device 102 via a browser.

By way of example and not limitation, the graphical user interface 500 includes one or more of widgets. A widget 502 may be configured to select a recipient. This widget may be used to select the recipient from the database if the recipient is a member of the retail system. Alternatively, the widget 502 may allow the user to enter details of the intended recipient, such as name, address, contact information, and so forth.

A widget 504 may be configured to select settings. This widget may allow users to control different settings of the product, such as a number of products, the way of shipping and delivery, and so forth.

A widget 506 may be configured to select an occasion. This widget may allow users to enter an occasion if the product is considered as a gift.

A widget 508 may be configured to select a date. This widget may allow users to select or enter the date of product delivery.

A widget 510 may be configured to create a message. This widget may allow users to create a message for the intended recipient. The message may be delivered to the recipient upon the product delivery. The message may include text, image, video, and audio content;

A widget 512 may be configured to select share details. This widget may allow users to predetermine settings for product shares. For example, the users may select a share value, number of shares, purchase details, and so forth.

A widget 514 may be configured to purchase shares. This widget may allow the user, who initiated the process of purchasing the product, to purchase one or more shares of the product according to predetermined settings.

A widget 516 may be configured to invite friends. This widget may allow users to invite other users to participate in purchasing shares of the product. Invitations may be delivered by e-mail, instant messages, SMS, MMS, blogging posts, social networking messages or posts, and the like. Thus, the users may invite their friends, other members of the retail system, relatives, colleagues, and so forth to contribute to the purchase of the preselected product. Invitation messages may contain hyperlinks to the product page or purchase page.

According to one example, the invited users may be directed to the purchase page having more limited functionality. In one example, the purchase page may include one or more widgets to review the product details, its description, preselected recipient details, occasion, and so forth; the widget 514 to purchase shares of the product; and the widget 516 to invite friends.

Upon selecting any of the widgets 502-516, the users may be directed to another page or website to complete the initiated process. After the process is initiated, the method of attributing the product is performed according to the description related to FIG. 3.

In some other embodiments, the graphical user interfaces 400 and 500 may include additional, fewer, or different modules for various applications. In addition, it should be mentioned that any one or more of the widgets 502-516 may be combined together.

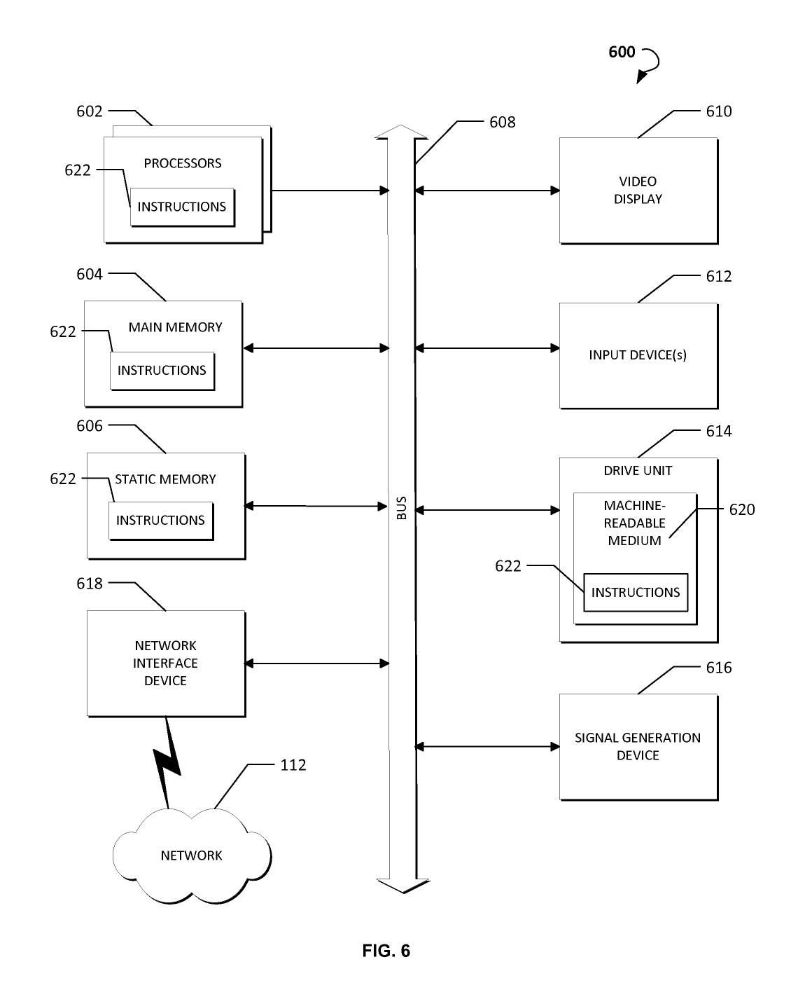

FIG. 6 shows a diagrammatic representation of a computing device for a machine in the example electronic form of a computer system 600, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a PC, a tablet PC, a set-top box (STB), a PDA, a cellular telephone, a portable music player (e.g., a portable hard drive audio device, such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor or multiple processors 602 (e.g., a central processing unit (CPU), a graphics processing unit (GPU), or both), a main memory 604, and a static memory 606, which communicate with each other via a bus 608. The computer system 600 may further include a video display unit 610 (e.g., a liquid crystal display (LCD) or a cathode ray tube (CRT)). The computer system 600 also includes at least one input device 612, such as an alphanumeric input device (e.g., a keyboard), a cursor control device (e.g., a mouse), a microphone, a digital camera, a video camera, and so forth. The computer system 600 also includes a disk drive unit 614, a signal generation device 616 (e.g., a speaker), and a network interface device 618.

The disk drive unit 614 includes a computer-readable medium 620 that stores one or more sets of instructions and data structures (e.g., instructions 622) embodying or utilized by any one or more of the methodologies or functions described herein. The instructions 622 may also reside, completely or at least partially, within the main memory 604 and/or within the processors 602 during execution thereof by the computer system 600. The main memory 604 and the processors 602 also constitute machine-readable media.

The instructions 622 may further be transmitted or received over the network 112 via the network interface device 618 utilizing any one of a number of well-known transfer protocols (e.g., Hyper Text Transfer Protocol (HTTP), CAN, Serial, and Modbus).

While the computer-readable medium 620 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media may also include, without limitation, hard disks, floppy disks, flash memory cards, digital video disks (DVDs), random access memory (RAM), read only memory (ROM), and the like.

The example embodiments described herein may be implemented in an operating environment comprising computer-executable instructions (e.g., software) installed on a computer, in hardware, or in a combination of software and hardware. The computer-executable instructions may be written in a computer programming language or may be embodied in firmware logic. If written in a programming language conforming to a recognized standard, such instructions may be executed on a variety of hardware platforms and a variety of operating system interfaces. Although not limited thereto, computer software programs for implementing the present method may be written in any number of suitable programming languages such as, for example, Hyper-text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

Although embodiments have been described with reference to specific example embodiments, it will be evident that various modifications and changes may be made to these example embodiments without departing from the broader spirit and scope of the present application. Accordingly, the specification and drawings are to be regarded in an illustrative rather than a restrictive sense.

What is claimed is:

1. A computer-implemented method for collective purchasing, the method comprising:
receiving, from a user, a user request to purchase one or more shares of a product;
purchasing the one or more shares of the product;
adding the one or more shares to a collective purchased share of the product;
analyzing the collective purchased share in relation to a total cost of the product; and
based on the analysis, selectively purchasing the product.

2. The computer-implemented method of claim 1, further comprising delivering the product to an intended recipient.

3. The computer-implemented method of claim 1, wherein the purchase is performed via an online store.

4. The computer-implemented method of claim 1, wherein the user provides credit card information to purchase the one or more shares of the product, the credit card being associated with the user.

5. The computer-implemented method of claim 1, wherein the user provides information associated with a non-monetary means to purchase the one or more shares of the product, wherein the non-monetary means include one or more of a point, a credit, and a mile.

6. The computer-implemented method of claim 1, wherein the analysis includes determining that the collective purchased share equals or exceeds the total cost of the product.

7. The computer implemented method of claim 6, wherein the user or an intended recipient obtains a gift card or a retail store credit as a compensation for the collective purchased amount exceeding the total cost of the product or purchases one or more other products for the collective purchased amount exceeding the total cost of the product.

8. The computer-implemented method of claim 1, further comprising:
receiving, from the user, information on an intended recipient.

9. The computer-implemented method of claim 1, further comprising:
receiving, from the user, one or more invitations to engage one or more further users in the collective purchasing;
receiving, from the user, identification information for the product; and
receiving, from the user, a price per a share of the product.

10. The computer-implemented method of claim 1, further comprising generating a unique product identifier related to the product.

11. A computer-implemented system for collective purchasing, the system comprising:
a database to store information associated with a product, a user, and an intended recipient;
a receiving module to receive, from the user, a user request to purchase one or more shares of the product;
an adding module to add the one or more shares to a collective purchased share of the product;
an analyzing module to analyze the collective purchased share in relation to a total cost of the product; and
a purchasing module to selectively purchase the product based on the analysis.

12. The computer-implemented system of claim 11, wherein the product is delivered to the intended recipient.

13. The computer-implemented system of claim 11, wherein the purchase is performed via an online store.

14. The computer-implemented system of claim 11, wherein the user provides information associated with a credit card to purchase the one or more shares of the product, the credit card being associated with the user.

15. The computer-implemented system of claim 11, wherein the user provides information associated with a non-monetary means to purchase the one or more shares of the product, wherein the non-monetary means includes one or more of a point, a credit, and a mile.

16. The computer-implemented system of claim 11, wherein the analysis includes determining that the collective purchased share equals or exceeds the total cost of the product.

17. The computer-implemented system of claim 16, wherein the user or the intended recipient obtains a gift card or a retail store credit as a compensation for the collective purchased amount exceeding the total cost of the product or purchases one or more other products for the collective purchased amount exceeding the total cost of the product.

18. The computer-implemented system of claim 17, further comprising:
receiving, from the user, information on the intended recipient.

19. The computer-implemented system of claim 11, further comprising:
receiving, from the user, one or more invitations to engage one or more other users in the collective purchasing;
receiving, from the user, identification information for the product; and
receiving, from the user, a price per a share of the product.

20. A computer-readable non-transitory medium having instructions stored thereon, which when executed by one or more computers, cause the one or more computers to:
receive, from a user, a user request to purchase one or more shares of a product;
add the one or more shares to a collective purchased share of the product;
analyze the collective purchased share in relation to a total cost of the product; and
based on the analysis, selectively perform a purchase of the product.
